(19) United States
(12) Patent Application Publication
(10) Pub. No.: US 2026/0126246 A1
(43) Pub. Date: May 7, 2026

(54) PROCESS FOR DEHYDRATION OF A GAS STREAM PRIOR TO CRYOGENIC CO2 FRACTIONATION

(71) Applicant: UOP LLC, Des Plaines, IL (US)

(72) Inventors: Anh Ngo, Cypress, TX (US); Bradley Russell, Longmont, CO (US); John D. Wilkinson, Midland, TX (US); Shubhra J. Bhadra, Naperville, IL (US); Nasser Khazeni, Arlington Heights, IL (US); Steven E. Zell, Salt Lake City, UT (US); Ali Hatami, Katy, TX (US); Christopher M. Dyszkiewicz, Burbank, IL (US); Erick J. Bennett, III, New Lenox, IL (US); Audra Van Doorn, Oak Park, IL (US); Gregory R. Werba, Arlington Heights, IL (US)

(21) Appl. No.: 19/311,351

(22) Filed: Aug. 27, 2025

Related U.S. Application Data
(60) Provisional application No. 63/715,152, filed on Nov. 1, 2024.

(51) Int. Cl. F25J 3/06; B01D 53/04; B01D 53/047; B01D 53/14; B01D 53/26; C01B 3/36; C01B 3/50; C01B 3/56; C10L 3/10

(52) U.S. Cl. CPC F25J 3/061; B01D 53/0462; B01D 53/047; B01D 53/1493; B01D 53/263; C01B 3/36; C01B 3/506; C01B 3/56; C10L 3/103; C10L 3/104; C10L 3/106; F25J 3/067; B01D 2256/18; B01D 2256/22; B01D 2257/304; B01D 2257/504; B01D 2257/80; C01B 2203/0205; C01B 2203/0244; C01B 2203/042; C01B 2203/046; C01B 2203/0475; C10L 2290/541; C10L 2290/542; C10L 2290/543

(57) ABSTRACT

Processes for recovery of carbon dioxide from a gas stream are described. The processes reduce dehydration cost in CO₂ capture systems and minimize the formation of COS and H₂O and enable water removal with an enhanced solvent-based absorbent operating at a lower temperature. This allows low residual water levels to be achieved in the dried gas. Also, feed streams containing high levels of CO₂ and H₂S can be treated in an integrated system comprising a cryogenic CO₂ fractionation system, an overhead pressure swing adsorption (PSA) unit, and a CO₂ temperature swing adsorption (TSA) unit. The processes allow recovery of helium and methane as well as CO₂ and H₂S.

### RELATED APPLICATIONS

This application claims priority to U.S. Provisional Patent Application Ser. No. 63/715,152, filed on Nov. 1, 2024, the entirety of which is incorporated herein by reference.

### BACKGROUND

There is increasing interest in capture and sequestration or utilization of carbon dioxide (CO₂) from industrial processes in order to avoid CO₂ emissions to the atmosphere. Carbon dioxide capture systems are currently being developed and commercialized for various applications, including flue gas streams from power generation plants, off gas streams from cement kilns and steel plants, and syngas streams from hydrogen production plants, among others. In addition to such industrial processes, carbon dioxide can also be recovered from sour natural gas extracted from underground reservoirs; the captured CO₂ can be re-injected into a reservoir for sequestration or enhanced oil recovery, thereby avoiding direct CO₂ emissions associated with the natural gas extraction. Various processes have been considered for CO₂ capture in such industrial processes, including solvent-based systems (e.g., amine units) and cryogenic CO₂ fractionation. Feed gas to the cryogenic process must generally be dried to remove moisture to a low level (e.g., <20 ppmv or lower) in order to prevent freezing in the downstream cryogenic system. Current practice is to use a solid adsorbent-based thermal swing adsorption (TSA) unit for this dehydration, often with a molecular sieve zeolite as the dessicant. However, these TSA units can be expensive. There is a need for a lower cost dehydration system to help reduce the overall cost of carbon capture.

It is well known in the art that solvent-based dehydration units offer certain benefits compared to molecular sieve TSA systems for gas dehydration, including a lower capital cost. These solvent based systems often use triethylene glycol (TEG) as the solvent and are commonly used in the natural gas processing industry for gas drying. However, the residual water concentration in the dried gas from a TEG unit is typically not suitable for the stringent requirements of a cryogenic system. Solvent dehydrators have therefore not generally been used upstream of a cryogenic process since a very low water specification is required to prevent freezing. However, in contrast to most cryogenic processes (such as liquefied natural gas recovery, nitrogen rejection units, air separation plants, etc), CO₂ fractionation operates at a higher temperature (about −55° C. is the lowest temperature in the process) and does not require water removal to the level required by most cryogenic units operating at much lower temperatures (e.g, <1 ppmv). Accordingly, solvent dehydrators can be considered as a lower cost alternative for use in cryogenic CO₂ capture units if appropriately designed to achieve a relatively low residue gas water specification (such as <20 ppmv). This can be accomplished by using an appropriate solvent and suitable operating conditions (such as feed gas temperature, regenerator temperature, use of stripping gas, and the like).

Some natural gas streams contain high concentrations of CO₂ and H₂S (sour natural gas), and in some cases these natural gas streams can also contain valuable quantities of helium which can be recovered. Processing these streams can lead to the formation of carbonyl sulfide (COS) and H₂O via the reverse hydrolysis reaction (COS+H₂O=CO₂+H₂S), leading to a potential water breakthrough in the molecular sieve dehydration unit and freezing in the downstream cryogenic CO₂ fractionation unit. There can also be a risk of COS and H₂O formation at other locations of the plant, which could also cause high water content in the gas circulating in the CO₂ fractionation unit, and a higher risk of freezing.

Therefore, there is a need for improved processes for CO₂ removal and helium recovery in gas streams having high concentrations of CO₂ and H₂S.

### BRIEF DESCRIPTION OF THE DRAWINGS

FIG. 1 is an illustration of one embodiment of a process for recovering carbon dioxide according to the present invention.

### DESCRIPTION

The present invention meets the above needs by providing processes which reduce dehydration cost in CO₂ capture systems and minimize the formation of COS and H₂O and enable water removal with an enhanced solvent-based absorbent operating at a lower temperature. This allows low residual water levels to be achieved in the dried gas. Also, feed streams containing high levels of CO₂ and H₂S can be treated in an integrated system comprising a cryogenic CO₂ fractionation system, an overhead pressure swing adsorption (PSA) unit, and a CO₂ temperature swing adsorption (TSA) unit. The process allows recovery of helium as well as CO₂ and H₂S from helium rich natural gas reservoirs containing high CO₂ and H₂S levels, such as those found in Wyoming and elsewhere.

The integrated process is designed with multiple features to minimize the formation of COS/H₂O. The process includes the use of a dehydration unit comprising a liquid solvent-based absorbent to remove moisture from the gas stream. It employs improved heat integration to chill the gas feed stream to the dehydration unit, and/or the dried gas feed stream from the dehydration unit, and/or the chilled dried gas feed stream to the CO₂ fractionation system to improve water removal performance and minimize reverse hydrolysis which could cause water breakthrough and freeze the cryogenic CO₂ fractionation system. The process can also use a low reactivity adsorbent material in the non-regeneration dehydration adsorber, such as silica gel. The CO₂ fractionation system is designed to have high tolerance of H₂O content in the gas feed stream (up to 20 ppmv) compared to most cryogenic processes (<1 ppmv).

In some embodiments, the process uses silica gel adsorbent in the overhead PSA unit to reduce risk of reverse COS hydrolysis.

One aspect of the invention is a process for recovery of carbon dioxide from a gas stream. In one embodiment, the process comprises removing water from a gas feed stream in a dehydration unit comprising a liquid solvent-based absorbent to form a dried gas stream; and removing carbon dioxide from the dried gas stream in a cryogenic carbon dioxide fractionation system comprising a cryogenic fractionation column to form a carbon dioxide product stream.

In some embodiments, the process further comprises chilling the gas feed stream and optionally the dried gas stream with the carbon dioxide product stream (e.g., −10° C. to 10° C.) from the cryogenic fractionation system forming a chilled gas feed stream, and optionally a chilled dried gas stream before removing the carbon dioxide. In some embodiments, the temperature of the gas feed stream is less than 50° C., or less than 45° C.

In some embodiments, the gas feed stream or the dried gas feed stream is chilled to a temperature of less than 45° C., or less than 40° C., or less than 35° C., or less than 30° C.

In some embodiments, the process further comprises chilling the gas feed stream and optionally the dried gas stream with a cold stream from the cryogenic carbon dioxide fractionation system before removing carbon dioxide. In some embodiments, the temperature of the gas feed stream is less than 50° C., or less than 45° C.

In some embodiments, the water concentration in the dried gas stream is less than 20 ppmv, or less than 10 ppmv, or less than 5 ppmv, or less than 1 ppmv.

In some embodiments, the liquid solvent comprises triethylene glycol, ethylene glycol, diethylene glycol, methanol, or formulated glycol solvents, such as Purdry™ 100 from Dow Chemical Co., or combinations thereof.

In some embodiments, the process further comprises: passing an overhead stream comprising-carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; and compressing the tail gas stream and recycling the compressed tail gas stream to the carbon dioxide fractionation system.

In some embodiments, the CO₂ concentration in the residue gas stream is less than 1 mol %.

In some embodiments, the process further comprises: separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide; and passing the regeneration gas stream to the overhead PSA unit.

In some embodiments, the CO₂ concentration in the CO₂ lean stream is less than 100 ppmv.

In some embodiments, the process further comprises passing the CO₂ lean stream to a cryogenic nitrogen rejection unit (NRU) to form a nitrogen lean stream comprising methane and helium and a nitrogen rich stream; and recovering the nitrogen lean stream.

In some embodiments, the process further comprises passing the nitrogen-lean stream to a helium recovery unit to form a residue gas stream comprising methane and a helium-enriched product stream comprising helium; and recovering the helium-enriched product stream.

In some embodiments, the process further comprises compressing the regeneration gas stream from the CO₂ TSA unit.

In some embodiments, the process further comprises selectively removing additional water from the dried gas stream with a non-regenerative adsorber before removing the carbon dioxide.

In some embodiments, the process further comprises: passing an overhead stream comprising-carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; compressing the tail gas stream and recycling the compressed tail gas stream to the carbon dioxide fractionation system.

In some embodiments, the process further comprises chilling the dried gas stream with a cold stream from the cryogenic carbon dioxide fractionation system before removing the additional water from the dried gas stream.

In some embodiments, the process further comprises removing additional water from the dried gas stream with a thermal swing adsorption (TSA) unit forming a water stream before removing the carbon dioxide.

In some embodiments, the process further comprises chilling the dried gas stream with a cold stream from the cryogenic carbon dioxide fractionation system before removing the additional water from the dried gas stream.

In some embodiments, the gas stream comprises a hydrocarbon stream, a synthesis gas stream, a flu gas stream, or combinations thereof.

Another aspect of the invention is a process for recovery of carbon dioxide from a gas stream. In one embodiment, the process comprises: chilling the gas feed stream with a carbon dioxide product stream from a cryogenic fractionation system forming a chilled gas feed stream; removing water from the chilled gas feed stream in a dehydration unit comprising a liquid solvent-based absorbent to form a dried gas stream; chilling the dried gas stream with the carbon dioxide product stream from the cryogenic fractionation system forming a chilled gas feed stream; removing carbon dioxide from the chilled dried gas stream in a cryogenic carbon dioxide fractionation system comprising a cryogenic fractionation column to form a carbon dioxide product stream; optionally chilling the gas feed stream, or the dried gas feed stream, or the chilled dried gas feed stream, or combinations thereof with a cold stream from the cryogenic carbon dioxide fractionation system before removing the carbon dioxide from the chilled dried gas feed stream; passing an overhead stream comprising carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; compressing the tail gas stream and recycling the compressed tail gas stream to the carbon dioxide fractionation system; separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide; passing the regeneration gas stream to the overhead PSA unit; passing the CO₂ lean stream to a cryogenic nitrogen rejection unit (NRU) to form a nitrogen lean stream comprising methane and helium and a nitrogen rich stream; passing the nitrogen-lean stream to a helium recovery unit to form a residue gas stream comprising methane and a helium-enriched product stream comprising helium; and recovering the helium-enriched product stream.

The process can be used for a wide variety of gas feed streams. For example, the gas feed stream may be a hydrocarbon feed stream, such as natural gas, comprising methane, CO₂, and at least one of H₂S, nitrogen, and helium. In this case, the CO₂ product stream chills the feed stream before the dehydration unit with the liquid solvent-based absorbent, or after it, or both, to improve the water removal and minimize the potential for COS reverse hydrolysis. The CO₂ is recovered, and the remaining components of the feed gas stream are separated in the overhead PSA unit, the CO₂ TSA unit, and the NRU. The helium can be recovered, and the methane can be recovered as pipeline natural gas.

Another example of a gas feed stream is a synthesis gas stream from a hydrogen production unit comprising hydrogen, CO₂, and at least one of methane, CO, nitrogen, and argon. In this case, the liquid absorbent-based dehydration unit removes water to an acceptable level in the dried gas upstream of the cryogenic CO₂ fractionation unit (e.g., less than 20 ppmv, or less than 10 ppmv, or less than 5 ppmv, or less than 1 ppmv). The liquid absorbent-based dehydration unit provides a lower capital cost compared to a conventional solid adsorbent dehydration unit based on thermal swing adsorption (TSA), thereby providing an economic advantage.

The gas feed stream could also be a flue gas stream comprising CO₂, nitrogen, and oxygen. The liquid absorbent-based dehydration unit removes water to an acceptable level in the dried gas upstream of the cryogenic CO₂ fractionation unit (e.g., less than 20 ppmv, or less than 10 ppmv, or less than 5 ppmv, or less than 1 ppmv). The liquid absorbent-based dehydration unit provides a lower capital cost compared to a conventional solid adsorbent dehydration unit based on thermal swing adsorption (TSA), thereby providing an economic advantage.

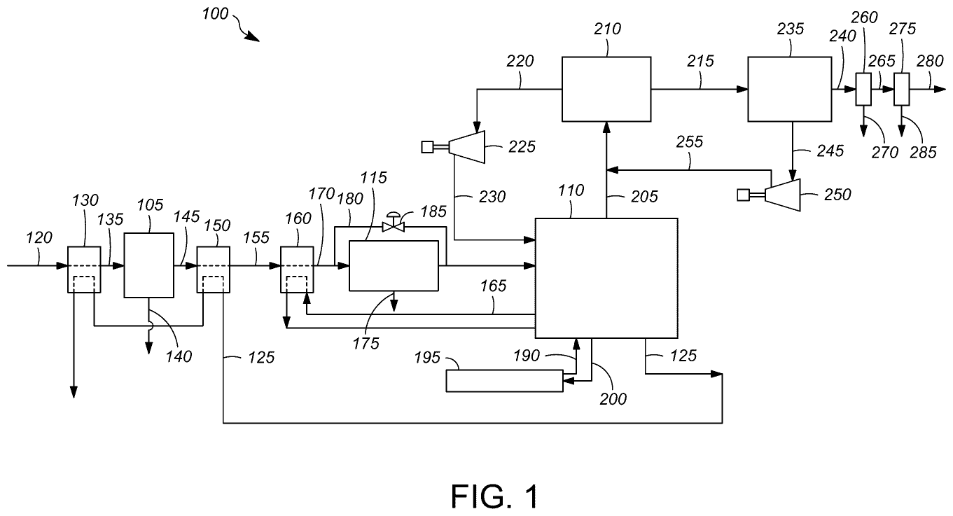

FIG. 1 shows one embodiment of a process 100. The process 100 includes a dehydration unit 105 and a cryogenic carbon dioxide fractionation system 110. It may optionally include a second water removal unit 115, such as a non-regenerative adsorber or a TSA unit. This second water removal unit can use a solid adsorbent such as silica gel or a molecular sieve zeolite.

The gas feed stream 120, which typically has a temperature of less than 50° C., is sent to a first chiller 130 where it is chilled using the CO₂ product stream 125 from the cryogenic carbon dioxide fractionation system 110. The chilled gas feed stream 135 is typically chilled to a temperature less than 45° C., or less than 40° C., or less than 35° C., or less than 30° C.

The chilled gas feed stream 135 is sent to the dehydration unit 105 where a water stream 140 is removed. The dried gas stream 145 is sent to a second chiller 150 where it is chilled using the CO₂ product stream 125 from the cryogenic carbon dioxide fractionation system 110 to form a chilled dried gas steam 155. The chilled dried gas stream 155 is typically chilled to a temperature less than 40° C., or less than 35° C., or less than 30° C., or less than 25° C. In some embodiments, rather than having both the first and second chillers 130 and 150, one or the other could be present.

The chilled dried gas stream 155 is sent to an optional third chiller 160 where it is chilled with a cold stream 165 from the cryogenic carbon dioxide fractionation system 110 to form a second chilled dried gas stream 170. The second chilled dried gas stream 170 is typically chilled to a temperature less than 35° C., or less than 30° C., or less than 25° C., or less than 20° C. The third chiller is downstream of the dehydration unit 105 and the second chiller 150 (if present). There could also be an optional fourth chiller (not shown) upstream of the first chiller 130.

The second chilled dried gas stream 170 is sent to an optional second water removal unit 115 for removal of an additional water stream 175. There can be a bypass line 180 to bypass the second water removal unit 115 with valve 185. For example, the valve 185 could be closed during start-up so that the second chilled dried gas stream 170 passes through the second water removal unit 115 for additional water removal and on to the cryogenic carbon dioxide fractionation system 110. Following the initial start-up, the valve 185 can be opened to allow the second chilled dried gas stream 170 to bypass the second water removal unit 115 and flow to the cryogenic carbon dioxide fractionation system 110 without passing through the second water removal unit 115.

In embodiments where the optional third chiller 160 is not present, the chilled dried gas stream 155 is sent to the optional second water removal unit 115 (if present) and to the cryogenic carbon dioxide fractionation system 110. In embodiments where the second chiller and the optional third chiller 160 are not present, the dried gas stream 145 is sent to the optional second water removal unit 115 (if present) and to the cryogenic carbon dioxide fractionation system 110.

CO₂ is removed from the second chilled dried gas stream 170 (or the chilled dried gas stream 155, or the dried gas stream 145, depending on the process). Refrigerant stream 190 from the refrigeration unit 195 is sent to the cryogenic carbon dioxide fractionation system 110, and the warmed refrigerant stream 200 is returned to the refrigeration unit 195. The CO₂ product stream 125 from the cryogenic carbon dioxide fractionation system 110 is used to chill the gas feed stream 120 or the dried gas stream 145 or both.

The overhead stream 205 from the cryogenic carbon dioxide fractionation system 110, which contains carbon dioxide and at least one of methane, hydrogen, nitrogen, carbon monoxide, argon, hydrogen sulfide, and helium, is sent to an overhead PSA unit 210. The overhead stream 205 is separated into a residue gas stream 215 comprising carbon dioxide and at least one of methane, nitrogen, hydrogen, carbon monoxide, argon, and helium, and a tail gas stream 220 comprising carbon dioxide. The CO₂ concentration in the residue gas stream 215 is typically less than 1 mol %.

The tail gas stream 220 is compressed in compressor 225, and the compressed stream 230 is recycled to the cryogenic carbon dioxide fractionation system 110.

The residue gas stream 215 is sent to a CO₂ TSA unit 235 and separated into a CO₂ lean stream 240 comprising at least one of methane, nitrogen, hydrogen, carbon monoxide, argon, and helium, and a regeneration gas stream 245 comprising carbon dioxide. The regeneration gas stream 245 is compressed in a second compressor 250, and the compressed regeneration stream 255 is recycled to the overhead PSA unit 210.

The CO₂ lean stream 240 is sent to a nitrogen rejection unit (NRU) 260 based on cryogenic fractionation and separated into a nitrogen lean stream 265 comprising methane and helium and a nitrogen rich stream 270. The nitrogen rich stream 270 is vented or recovered.

The nitrogen lean stream 265 is sent to a helium recovery unit 275 and separated into a helium-enriched product stream 280 comprising helium, and a second residue gas stream 285 comprising methane. The helium-enriched product stream 280 is recovered and further treated if needed. The second residue gas stream 285 is recovered as pipeline natural gas.

### EXAMPLES

### Example 1. Sour Natural Gas Containing Helium

The first example shows a natural gas stream that is extracted from an underground reservoir. This gas stream is saturated with water and comprises a large amount of acid gases (CO₂ and H₂S), along with valuable helium and methane products to be recovered. After dehydration of the gas feed stream, the acid gases (CO₂ and H₂S) are removed by the cryogenic fractionation process in FIG. 1. The liquid CO₂ and H₂S rich stream from the bottom of the fractionation column is pumped to high pressure (1980 psig) prior to chilling the dried gas feed stream and the inlet gas stream. The CO₂ and H₂S rich stream is then re-injected into an underground reservoir (separate from the inlet gas reservoir). The water content in the dried feed gas is reduced to 5 ppmv by the liquid absorbent (triethylene glycol) dehydration unit upstream of the cryogenic system. Chilling the gas feed stream from 50° C. to 40° C. upstream of the dehydration unit reduces the water content and also increases the water capacity of the solvent, thereby enabling the low water specification of 5 ppmv in the dried gas, as shown in Table 1.

TABLE 1

| | Gas Feed | Chilled Gas | Dried |
|---|---|---|---|
| | Stream | Feed Stream | Gas Stream |
| Pressure, bar(g) | 83.0 | 82.6 | 81.0 |
| Temperature, ° C. | 50 | 40 | 43 |
| Composition, mol % | | | |
| Helium | 0.62 | 0.62 | 0.63 |
| Carbon Dioxide | 65.78 | 65.87 | 66.04 |
| Hydrogen Sulfide | 4.93 | 4.94 | 4.95 |
| Carbonyl Sulfide | 447 ppmv | 448 ppmv | 449 ppmv |
| Nitrogen | 7.87 | 7.88 | 7.90 |
| Methane | 20.23 | 20.26 | 20.32 |
| Water | 0.41 | 0.28 | 5 ppmv |
| Argon | 598 ppmv | 598 ppmv | 600 ppmv |
| Propane | 189 ppmv | 189 ppmv | 190 ppmv |
| Hydrogen | 60 ppmv | 60 ppmv | 60 ppmv |
| Ethane | 30 ppmv | 30 ppmv | 30 ppmv |
| i-Butane | 25 ppmv | 25 ppmv | 25 ppmv |
| n-Butane | 10 ppmv | 10 ppmv | 10 ppmv |
| Methanol | 199 ppmv | 149 ppmv | 200 ppmv |
| Neon | 10 ppmv | 10 ppmv | 10 ppmv |
| Total | 100.00 | 100.00 | 100.00 |

### Example 2. Compressed Hydrogen PSA Tail Gas from ATR-Based Blue Hydrogen Process

The second example shows a similar cryogenic CO₂ fractionation process used to capture CO₂ from a syngas stream in a hydrogen production process. In this case, an autothermal reforming (ATR) process is used to convert natural gas feedstock to hydrogen rich syngas. The syngas is first passed to a pressure swing adsorption (PSA) unit to recovery high-purity hydrogen product. Low-pressure tail gas from the PSA unit is enriched in CO₂. This tail gas is compressed from 0.4 barg to 42 barg and then cooled to 50° C. to form the water-saturated gas feed stream shown below. A cryogenic CO₂ fractionation process similar to the process shown in FIG. 1 is used to recover purified liquid CO₂ which is then pumped to a high pressure (2200 psig) and sent to a high-pressure pipeline for ultimate sequestration in a geological reservoir. The gas feed stream is chilled with product CO₂ from 50° C. to 37° C. upstream of the triethylene glycol-based dehydration unit in order to remove additional water from the gas feed stream and to increase the solvent water capacity. This chilling enables the dehydration unit to achieve a low water content (5 ppmv) in the dried gas stream.

TABLE 2

| | Gas Feed | Chilled Gas | Dried |
|---|---|---|---|
| | Stream | Feed Stream | Gas Stream |
| Pressure, bar(g) | 42.0 | 41.6 | 40.0 |
| Temperature, ° C. | 50 | 37 | 39 |
| Composition, mol % | | | |
| Helium | 4 ppmv | 4 ppmv | 4 ppmv |
| Carbon Dioxide | 72.91 | 72.98 | 73.17 |
| Nitrogen | 0.88 | 0.89 | 0.89 |
| Methane | 3.89 | 3.90 | 3.91 |
| Water | 0.38 | 0.26 | 5 ppmv |
| Argon | 50 ppmv | 50 ppmv | 50 ppmv |
| Hydrogen | 19.75 | 19.78 | 19.83 |
| Methanol | 74 ppmv | 56 ppmv | 56 ppmv |
| Carbon Monoxide | 2.18 | 2.18 | 2.19 |
| Total | 100.00 | 100.00 | 100.00 |

### Example 3. Compressed Flue Gas from SMR Furnace

The third example shows a similar cryogenic CO₂ fractionation process used to capture CO₂ from a hydrogen production process. In this case, the gas stream is a flue gas stream from a steam-methane reforming (SMR) furnace. This flue gas stream is compressed to 11 barg and cooled to 45° C. forming a pressurized, water-saturated gas feed stream. This gas feed stream is chilled with product CO₂ from the cryogenic fractionation process to a temperature of 35° C. upstream of the triethylene glycol dehydration unit in order to remove additional water from the gas feed stream and to increase the solvent water capacity. This chilling enables the dehydration unit to achieve a low water content (5 ppmv) in the dried gas stream, as shown in Table 3.

| | Gas Feed | Chilled Gas | Dried |
|---|---|---|---|
| | Stream | Feed Stream | Gas Stream |
| Pressure, bar(g) | 11.0 | 10.7 | 9.5 |
| Temperature, ° C. | 45 | 35 | 36 |
| Composition, mol % | | | |
| Oxygen | 2.59 | 2.60 | 2.61 |
| Carbon Dioxide | 19.58 | 19.61 | 19.71 |
| Nitrogen | 76.26 | 76.39 | 76.78 |
| Water | 0.68 | 0.50 | 5 ppmv |
| Argon | 0.89 | 0.90 | 0.90 |
| Sulfur Dioxide | 3 ppmv | 3 ppmv | 3 ppmv |
| Total | 100.00 | 100.00 | 100.00 |

### SPECIFIC EMBODIMENTS

While the following is described in conjunction with specific embodiments, it will be understood that this description is intended to illustrate and not limit the scope of the preceding description and the appended claims.

A first embodiment of the invention is a process for recovery of carbon dioxide from a gas stream comprising removing water from a gas feed stream in a dehydration unit comprising a liquid solvent-based absorbent to form a dried gas stream; and removing carbon dioxide from the dried gas stream in a cryogenic carbon dioxide fractionation system comprising a cryogenic fractionation column to form a carbon dioxide product stream. An embodiment of the invention is one, any or all of prior embodiments in this paragraph up through the first embodiment in this paragraph further comprising chilling the gas feed stream and optionally the dried gas stream with the carbon dioxide product stream from the cryogenic fractionation system forming a chilled gas feed stream, and optionally a chilled dried gas stream before removing the carbon dioxide. An embodiment of the invention is one, any or all of prior embodiments in this paragraph up through the first embodiment in this paragraph wherein a temperature of the gas feed stream is less than 50° C. An embodiment of the invention is one, any or all of prior embodiments in this paragraph up through the first embodiment in this paragraph further comprising chilling the gas feed stream and optionally the dried gas stream with a cold stream from the cryogenic carbon dioxide fractionation system before removing carbon dioxide. An embodiment of the invention is one, any or all of prior embodiments in this paragraph up through the first embodiment in this paragraph wherein a temperature of the gas feed stream is less than 50° C. An embodiment of the invention is one, any or all of prior embodiments in this paragraph up through the first embodiment in this paragraph wherein a water concentration in the dried gas stream is less than 20 ppmv. An embodiment of the invention is one, any or all of prior embodiments in this paragraph up through the first embodiment in this paragraph wherein the liquid solvent comprises triethylene glycol. An embodiment of the invention is one, any or all of prior embodiments in this paragraph up through the first embodiment in this paragraph further comprising passing an overhead stream comprising carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; and compressing the tail gas stream and recycling the compressed tail gas stream to the cryogenic carbon dioxide fractionation system. An embodiment of the invention is one, any or all of prior embodiments in this paragraph up through the first embodiment in this paragraph wherein a CO₂ concentration in the residue gas stream is less than 1 mol %. An embodiment of the invention is one, any or all of prior embodiments in this paragraph up through the first embodiment in this paragraph further comprising separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide; and passing the regeneration gas stream to the overhead PSA unit. An embodiment of the invention is one, any or all of prior embodiments in this paragraph up through the first embodiment in this paragraph wherein a CO₂ concentration in the CO₂ lean stream is less than 100 ppmv. An embodiment of the invention is one, any or all of prior embodiments in this paragraph up through the first embodiment in this paragraph further comprising passing the CO₂ lean stream to a cryogenic nitrogen rejection unit (NRU) to form a nitrogen lean stream comprising methane and helium and a nitrogen rich stream; and recovering the nitrogen lean stream. An embodiment of the invention is one, any or all of prior embodiments in this paragraph up through the first embodiment in this paragraph further comprising passing the nitrogen-lean stream to a helium recovery unit to form a residue gas stream comprising methane and a helium-enriched product stream comprising helium; and recovering the helium-enriched product stream. An embodiment of the invention is one, any or all of prior embodiments in this paragraph up through the first embodiment in this paragraph further comprising compressing the regeneration gas stream from the CO₂ TSA unit. An embodiment of the invention is one, any or all of prior embodiments in this paragraph up through the first embodiment in this paragraph further comprising selectively removing additional water from the dried gas stream with a non-regenerative adsorber before removing the carbon dioxide. An embodiment of the invention is one, any or all of prior embodiments in this paragraph up through the first embodiment in this paragraph further comprising passing an overhead stream comprising-carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; compressing the tail gas stream and recycling the compressed tail gas stream to the carbon dioxide fractionation system. An embodiment of the invention is one, any or all of prior embodiments in this paragraph up through the first embodiment in this paragraph further comprising chilling the dried gas stream with a cold stream from the cryogenic carbon dioxide fractionation system before removing the additional water from the dried gas stream. An embodiment of the invention is one, any or all of prior embodiments in this paragraph up through the first embodiment in this paragraph further comprising removing additional water from the dried gas stream with a thermal swing adsorption (TSA) unit forming a water stream before removing the carbon dioxide. An embodiment of the invention is one, any or all of prior embodiments in this paragraph up through the first embodiment in this paragraph further comprising chilling the dried gas stream with a cold stream from the cryogenic carbon dioxide fractionation system before removing the additional water from the dried gas stream. An embodiment of the invention is one, any or all of prior embodiments in this paragraph up through the first embodiment in this paragraph wherein the gas stream comprises a hydrocarbon stream, a synthesis gas stream, a flu gas stream, or combinations thereof.

A second embodiment of the invention is a process for recovery of carbon dioxide from a gas stream comprising chilling the gas feed stream with a carbon dioxide product stream from a cryogenic fractionation system forming a chilled gas feed stream; removing water from the chilled gas feed stream in a dehydration unit comprising a liquid solvent-based absorbent to form a dried gas stream; chilling the dried gas stream with the carbon dioxide product stream from the cryogenic fractionation system forming a chilled gas feed stream; removing carbon dioxide from the chilled dried gas stream in a cryogenic carbon dioxide fractionation system comprising a cryogenic fractionation column to form a carbon dioxide product stream; optionally chilling the gas feed stream, or the dried gas feed stream, or the chilled dried gas feed stream, or combinations thereof with a cold stream from the cryogenic carbon dioxide fractionation system before removing the carbon dioxide from the chilled dried gas feed stream; passing an overhead stream comprising carbon dioxide and at least one of methane, hydrogen, nitrogen, carbon monoxide, argon, hydrogen sulfide, and helium from the cryogenic carbon dioxide fractionation column to an overhead pressure swing adsorption unit; separating the overhead stream into a residue gas stream comprising carbon dioxide and at least one of methane, nitrogen, hydrogen, carbon monoxide, argon, and helium, and a tail gas stream comprising carbon dioxide; compressing the tail gas stream and recycling the compressed tail gas stream to the carbon dioxide fractionation system; separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide; passing the regeneration gas stream to the overhead PSA unit; passing the CO₂ lean stream to a cryogenic nitrogen rejection unit (NRU) to form a nitrogen lean stream comprising methane and helium and a nitrogen rich stream; passing the nitrogen-lean stream to a helium recovery unit to form a residue gas stream comprising methane and a helium-enriched product stream comprising helium; and recovering the helium-enriched product stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for recovery of carbon dioxide from a gas stream comprising:
removing water from a gas feed stream in a dehydration unit comprising a liquid solvent-based absorbent to form a dried gas stream; and
removing carbon dioxide from the dried gas stream in a cryogenic carbon dioxide fractionation system comprising a cryogenic fractionation column to form a carbon dioxide product stream.

2. The process of claim 1 further comprising:
chilling the gas feed stream and optionally the dried gas stream with the carbon dioxide product stream from the cryogenic fractionation system forming a chilled gas feed stream, and optionally a chilled dried gas stream before removing the carbon dioxide.

3. The process of claim 2 wherein a temperature of the gas feed stream is less than 50° C.

4. The process of claim 1 further comprising:
chilling the gas feed stream and optionally the dried gas stream with a cold stream from the cryogenic carbon dioxide fractionation system before removing carbon dioxide.

5. The process of claim 4 wherein a temperature of the gas feed stream is less than 50° C.

6. The process of claim 1 wherein a water concentration in the dried gas stream is less than 20 ppmv.

7. The process of claim 1 wherein the liquid solvent comprises triethylene glycol, ethylene glycol, diethylene glycol, methanol, or formulated glycol solvents, or combinations thereof.

8. The process of claim 1 further comprising:
passing an overhead stream comprising carbon dioxide and at least one of methane, hydrogen, nitrogen, carbon monoxide, argon, hydrogen sulfide, and helium from the cryogenic carbon dioxide fractionation column to an overhead pressure swing adsorption unit;
separating the overhead stream into a residue gas stream comprising carbon dioxide and at least one of methane, nitrogen, hydrogen, carbon monoxide, argon, and helium, and a tail gas stream comprising carbon dioxide; and
compressing the tail gas stream and recycling the compressed tail gas stream to the cryogenic carbon dioxide fractionation system.

9. The process of claim 8 further comprising:
separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide, wherein a CO₂ concentration in the residue gas stream is less than 1 mol %; and
passing the regeneration gas stream to the overhead PSA unit.

10. The process of claim 9 where a CO₂ concentration in the CO₂ lean stream is less than 100 ppmv.

11. The process of claim 9 further comprising:
passing the CO₂ lean stream to a cryogenic nitrogen rejection unit (NRU) to form a nitrogen lean stream comprising methane and helium and a nitrogen rich stream; and
recovering the nitrogen lean stream.

12. The process of claim 11 further comprising:
passing the nitrogen-lean stream to a helium recovery unit to form a residue gas stream comprising methane and a helium-enriched product stream comprising helium; and
recovering the helium-enriched product stream.

13. The process of claim 9 further comprising:
compressing the regeneration gas stream from the CO₂ TSA unit.

14. The process of claim 1 further comprising:
selectively removing additional water from the dried gas stream with a non-regenerative adsorber before removing the carbon dioxide.

15. The process of claim 14 further comprising:
passing an overhead stream comprising-carbon dioxide and at least one of methane, hydrogen, nitrogen, carbon monoxide, argon, hydrogen sulfide, and helium from the cryogenic carbon dioxide fractionation column to an overhead pressure swing adsorption unit;
separating the overhead stream into a residue gas stream comprising carbon dioxide and at least one of methane, nitrogen, hydrogen, carbon monoxide, argon, and helium, and a tail gas stream comprising carbon dioxide; and
compressing the tail gas stream and recycling the compressed tail gas stream to the carbon dioxide fractionation system.

16. The process of claim 14 further comprising:
chilling the dried gas stream with a cold stream from the cryogenic carbon dioxide fractionation system before removing the additional water from the dried gas stream.

17. The process of claim 1 further comprising:
removing additional water from the dried gas stream with a thermal swing adsorption (TSA) unit forming a water stream before removing the carbon dioxide.

18. The process of claim 17 further comprising:
chilling the dried gas stream with a cold stream from the cryogenic carbon dioxide fractionation system before removing the additional water from the dried gas stream.

19. The process of claim 1 wherein the gas stream comprises a hydrocarbon stream, a synthesis gas stream, a flue gas stream, or combinations thereof.

20. A process for recovery of carbon dioxide from a gas stream comprising:
chilling the gas feed stream with a carbon dioxide product stream from a cryogenic fractionation system forming a chilled gas feed stream;
removing water from the chilled gas feed stream in a dehydration unit comprising a liquid solvent-based absorbent to form a dried gas stream;
chilling the dried gas stream with the carbon dioxide product stream from the cryogenic fractionation system forming a chilled gas feed stream;
removing carbon dioxide from the chilled dried gas stream in a cryogenic carbon dioxide fractionation system comprising a cryogenic fractionation column to form a carbon dioxide product stream;
optionally chilling the gas feed stream, or the dried gas feed stream, or the chilled dried gas feed stream, or combinations thereof with a cold stream from the cryogenic carbon dioxide fractionation system before removing the carbon dioxide from the chilled dried gas feed stream;
passing an overhead stream comprising carbon dioxide and at least one of methane, hydrogen, nitrogen, carbon monoxide, argon, hydrogen sulfide, and helium from the cryogenic carbon dioxide fractionation column to an overhead pressure swing adsorption unit;
separating the overhead stream into a residue gas stream comprising carbon dioxide and at least one of methane, nitrogen, hydrogen, carbon monoxide, argon, and helium, and a tail gas stream comprising carbon dioxide;
compressing the tail gas stream and recycling the compressed tail gas stream to the carbon dioxide fractionation system;
separating the residue gas stream in a CO₂ thermal swing adsorption (TSA) unit into a CO₂ lean stream comprising at least one of methane, nitrogen, hydrogen, carbon monoxide, argon, and helium, and a regeneration gas stream comprising carbon dioxide;
passing the regeneration gas stream to the overhead PSA unit;
passing the CO₂ lean stream to a cryogenic nitrogen rejection unit (NRU) to form a nitrogen lean stream comprising methane and helium and a nitrogen rich stream;
passing the nitrogen-lean stream to a helium recovery unit to form a residue gas stream comprising methane and a helium-enriched product stream comprising helium; and
recovering the helium-enriched product stream.
